(19) United States
(12) Patent Application Publication
(10) Pub. No.: US 2014/0264987 A1
(43) Pub. Date: Sep. 18, 2014

(54) METHOD OF MANUFACTURING PHOSPHOR TRANSLUCENT CERAMICS AND LIGHT EMITTING DEVICES

(71) Applicant: NITTO DENKO CORPORATION, Osaka (JP)

(72) Inventors: James C. Shih, Artesia, CA (US); Hiroaki Miyagawa, Oceanside, CA (US)

(21) Appl. No.: 13/843,731

(22) Filed: Mar. 15, 2013

(51) Int. Cl. C08K 3/32

(52) U.S. Cl. CPC C08K 3/32
USPC 264/21

(57) ABSTRACT

Disclosed herein is a method of increasing the luminescent efficiency of a translucent phosphor ceramic. Other embodiments are methods of manufacturing a phosphor translucent ceramic having increased luminescence. Another embodiment is a light emitting device comprising a phosphor translucent ceramic of one of these methods.

### BACKGROUND OF THE INVENTION

1. Field of the Invention

This invention relates to light emitting devices, such as light emitting devices comprising phosphor translucent ceramics.

2. Description of the Related Art

White light-emitting devices may be fabricated using a combination of a blue light-emitting diode (LED) and a phosphor material. These devices are often configured so that the blue light from the blue light-emitting diode comes in contact with the phosphor material so that the phosphor material may absorb a portion of the blue light and emit light that is of a longer wavelength. As a result, these materials have been described as wavelength converting or color changing. This allows the device to emit a combination of light that appears more white. There are two common methods for doing so. First, the phosphor particles may be dispersed in another solid component through which the light passes, thus coming into contact with the dispersed phosphor particles. Second, the phosphor material may be in the form of a phosphor ceramic compact, in which case the blue light would pass through the compact.

The disadvantage of the phosphor particles is that particles that are large enough to be emissive have a tendency to scatter the light, thus reducing the light emission of the device. In addition, since the difference in refractive index between air and the matrix material is so great, the scattering achieved by the air voids decreases the transparency of the material and raises the scattering to too high a level, resulting in decreased transmissive efficiency (IQE). Such transmissive elements result in insufficient total transmission through the element, resulting in undesired loss of light through the lateral edges of the element and insufficient transmission of light through the element. Thus there is a need for a translucent ceramic that balance these issues and provides an element with high IQE and transparency.

On the other hand, the phosphor ceramic compacts are generally prepared by sintering under conditions that may affect the luminescent efficiency and/or other physical characteristics of the phosphor ceramic. Sintering has been achieved under a vacuum, a dry reducing atmosphere, a nitriding atmosphere and/or an inert atmosphere. Nitrifying atmospheres can increase the hardness of the treated ceramic, but does not maintain material transparency. Dry H₂ sintering tends to exaggerate grain growth, resulting in average grain sizes of greater that 5 um in diameter. Sintering too quickly, for example at a higher temperature, can result in too rapid a densification of the green sheet, essentially resulting in a transparent element without the desired amount of scattering. Furthermore, the conventional atmospheric conditions for sintering of phosphor materials are usually under a vacuum, which may require more instrumentation to provide the necessary level of vacuum, increasing the overall manufacturing costs. Thus, there is a need for a translucent phosphor ceramic compact with improved luminescence with a desired amount of scattering and total transmittance through the compact.

### SUMMARY OF THE INVENTION

Some embodiments provide a method of increasing the luminescent efficiency of a translucent phosphor ceramic, comprising sintering the translucent phosphor ceramic in a non-oxidizing atmosphere at a temperature of at least about 1700° C. thereby increasing the luminescence efficiency. In some embodiments, the non-oxidizing atmosphere comprises between 94% to about 100% inert gas and about 0% to about 6% reducing gas. In some embodiments the inert gas can be nitrogen. In some embodiments, the reducing gas can be hydrogen.

Some embodiments provide a method of manufacturing a phosphor translucent ceramic having an increased luminescence. The method comprises providing a precursor composition and heating the precursor composition under a non-oxidizing or a reducing atmosphere.

Some embodiments provide a method of manufacturing a phosphor translucent ceramic compact having increased luminescence. The method comprises providing a precursor composition; heating the precursor composition at a temperature sufficient to form a translucent phosphor ceramic; and heating the translucent phosphor ceramic at a temperature of at least about 1700° C. under a reducing atmosphere.

### BRIEF DESCRIPTION OF THE DRAWINGS

FIG. 1 is a schematic diagram of one example of a device comprising a phosphor translucent ceramic disclosed herein.

FIG. 2 is a schematic diagram of an alternate example of a device comprising a phosphor translucent ceramic disclosed herein.

FIG. 3 is a schematic diagram of an alternate example of a device comprising a phosphor translucent ceramic disclosed herein.

FIG. 4 shows another embodiment of a device comprising a phosphor translucent ceramic disclosed herein.

FIG. 5 is a plot of the % transmission of elements comprising various ceramic embodiments.

FIG. 6 is a plot of the IQE of elements comprising various ceramic embodiments.

FIG. 7 is a plot of average grain size of elements comprising various embodiments.

### DETAILED DESCRIPTION OF EMBODIMENTS

During sintering process, there are four competing mechanisms: (1) densification and shrinkage of light scattering voids, (2) grain growth, (3) Ce and Gd dopant diffusion, and (4) solid state reaction for the formation of Garnet host lattices. These four mechanisms must be properly controlled to achieve optimized luminescence performance. If any mechanism becomes dominant, the other three may be suppressed, resulting in poorer performance. Sintering atmospheres affects these four competing mechanisms.

Unless otherwise indicated, “annealing,” “anneal,” or “annealed” refers to applying heat to a material to convert at least part of the material from one phase to another desired phase. Thus, for example, in some embodiments, the annealing of a phosphor powder may involve the conversion of yttrium amorphous or yttrium aluminum perovskite (YAP) phase material to yttrium aluminum garnet material. Annealing also primarily substantially removes point defects, usually oxygen positions, in the garnet lattice.

Unless otherwise indicated, “densifying”, “sintering,” “sinter,” or “sintered,” refers to applying heat to a material to make more dense at least a portion of the material into a ceramic material. In some embodiments, this may be done by heating the material below its melting temperature, but enabling at least a portion of a plurality of particles of the material to adhere together and/or fill voids disposed between the particles. In some embodiments, the material is made more dense in a manner to retain some material particles/minimal amount of void creation.

One embodiment provides a method of preparing a translucent phosphor ceramic that has both high luminous efficiency and high transparency. In some embodiments, the high luminous efficiency results in a compact characterized by an IQE of at least 60%, at least 70%, and at least 80%. In some embodiments, the sintered, but not annealed compact is characterized by a transparency, at about 60%, at least 65%, and/or at least 70%. In some embodiments, the method can include providing a precursor composition and heating the precursor composition under a non-oxidizing or a reducing atmosphere at atmospheric pressure, reduced pressure, or above atmospheric pressure. In some embodiments, the reduced pressure can be at or under a vacuum. The term “translucent phosphor ceramic” refers to a ceramic object that is translucent and comprises a plurality of phosphor particles which have adhered to one another to form a single piece object. In some embodiments, the translucent phosphor ceramic consists essentially of sintered phosphor particles. In some embodiments, the translucent ceramic is substantially free of one or more of binders, solvents, dispersants and/or flux materials. In some embodiments, the translucent ceramic can define a plurality of voids, on the order of about 3% total volume with an average void size of about 4 um. In some embodiments, the translucent phosphor ceramic may be prepared by a process comprising heating at least part of a plurality of particles. The plurality of particles may be any plurality of particles that can be converted to a translucent phosphor ceramic by the processes described herein. For example, the plurality of particles may be a plurality of phosphor particles, ceramic raw particles or ceramic raw materials.

In some embodiments, a precursor composition comprising a ceramic raw material or a ceramic phosphor precursor is provided. In some embodiments, the ceramic phosphor precursor may comprise inorganic phosphor material or a plurality of phosphor particles. In some embodiments, precursor powders made by any method, including those that are commercially available (e.g., purchased commercially), can be mixed in desired stoichiometric amounts prior to the formation of the compact and/or sintering step. The precursor powders may, or may not, be phosphor particles when initially mixed together. For example, when making a ceramic plate with Y₃Al₅O₁₂:Ce³⁺, stoichiometric amounts of Y₂O₃, Al₂O₃ and CeO₂ powders can be mixed together. In some embodiments, the ceramic raw material comprises raw powders of phosphor materials with an average particle size of less than about 1000 nm. In some embodiments, raw powders of phosphor materials may have an average particle size of less than about 500 nm. The raw materials or powders do not need to have the same composition or crystal structure as the resultant phosphor ceramic plate or compact. For example, to prepare a YAG:Ce translucent ceramic plate, YAG:Ce powder, Y—Al—O—Ce containing amorphous powders, mixture of YAlO₃:Ce and Al₂O₃ powders, mixture of Y₂O₃, Al₂O₃ and CeO₂ powders, and any combination thereof may be used as the raw material.

In some embodiments, the plurality of particles or the ceramic phosphor precursor may comprise (A₁₋ₓEₓ)₃B₅O₁₂, wherein A is Y, Gd, La, Lu, Tb, or a combination thereof; x is from about 0.00005 to about 0.1; B is Al, Ga, In, or a combination thereof; and E is Ce, Eu, Tb, Nd, or a combination thereof. In some embodiments, x is from about 0.0001 to about 0.01, or alternatively, from about 0.001 to about 0.005. In some embodiments, the ceramic raw materials include Y, such as Y₂O₃; Gd, such as Gd₂O₃; Al, such as Al₂O₃; and/or Ce, such as CeO₂.

In some embodiments, the ceramic phosphor precursor comprises Y, Gd, and Ce. The relative molar amount of Y may be 80% to nearly 100%, about 85% to about 95%, or about 90%, with respect to the total number of moles of Y, Gd, and Ce together. The relative molar amount of Gd may be may be greater than or equal to 0% and up to about 20%, about 5% to about 15%, or about 10%, with respect to the total number of moles of Y, Gd, and Ce together. The relative molar amount of Ce may be may be greater than or equal to 0 and up to about 1%, about 0.01% to about 0.1%, or about 0.05%, with respect to the total number of moles of Y, Gd, and Ce together. In some embodiments, the ceramic phosphor precursor comprises about 90% Y, about 10% Gd, and about 0.005% Ce, with respect to the total number of moles of Y, Gd, and Ce together being about 100%.

In some embodiments, the translucent phosphor ceramic comprises (YₐGd_{b}Ce_{c})₃B₅O₁₂. In these embodiments, a+b+c is about 1. The value of a may be about 0.8 to nearly 1, about 0.85 to about 0.95, or about 0.9. The value of b may be may be greater than or equal to 0 and up to about 0.2, about 0.05 to about 0.15, or about 0.1. The value of c may be greater than or equal to 0 and up to about 0.01, about 0.0001 to about 0.001, or about 0.0005. In some embodiments, a is about 0.9, b is about 0.1, and c is about 0.0005.

In some embodiments, additional material such as binder resin, dispersant, and/or solvent may be added to the precursor composition to aid the mixing and molding processes. A binder is any substance that improves adhesion of the particles of the composition being heated to form a ceramic solid. Some non-limiting examples of binders include polyvinyl alcohol, polyvinyl acetate, polyvinyl chloride, polyvinyl butyral, polystyrene, polyethylene glycol, polyvinylpyrrolidones, polyvinyl acetates, and polyvinyl butyrates, etc. In some, but not all, circumstances, it may be useful for the binder to be sufficiently volatile that it can be completely removed or eliminated from the precursor mixture during the sintering phase.

The ceramic phosphor precursor can then be mixed and molded into a precursor compact. In some embodiments, the mixing process may be done using mortar and pestle, ball milling machine, or bead milling machine. In some embodiments, the molding process may involve using a simple die for tablet molding, hot isostatic pressing (HIP) or cold isostatic pressing (CIP). In some embodiments, controlled quantities of raw powders may be loaded into a mold followed by applying pressure to form a molded precursor compact. In other embodiments, slip casting of slurry solution of precursor composition may be utilized to make molded precursor compact. In some embodiments, small quantity of flux materials may be added to the precursor composition for improving sintering property. The term “flux material” refers to a substance that may increase the crystallinity of the phosphor or may reduce the sintering temperature by facilitating the sintering property of the ceramic. Examples of flux materials include, but are not limited to, alkali metal halides such as NaCl or KCl, silicon-containing materials, such as silica, magnesium containing materials such as MgO, and tetraethyl orthosilicate, and organic compounds such as urea. In some embodiments, organic material, e.g., generally spherical beads of desired material, can be provided for mixture in the precursor matrix. In some embodiments, the beads can be polymeric beads. In some embodiments, the beads can be MA1006 (Nippon Shokubai) and/or SSX108 (SekiSui). In some embodiments, the beads are substantially entirely below 15 μm in diameter. In some embodiments, the beads can be SSX108 beads.

In some embodiments, prior to sintering the precursor compact, binder resin and/or residual organic matters may be removed from the precursor compact by a thermal pre-treatment. In these embodiments, the precursor compact may be heated in an atmosphere comprising oxygen, such as air, to a temperature high enough to decompose the binder resin. The atmosphere comprising oxygen gas may contain one or more additional inert gases. For example, mixtures of oxygen and argon or oxygen and nitrogen may be used. In one embodiment, the atmosphere comprising oxygen gas is air. In some embodiments, the precursor compact is heated to a temperature high enough to facilitate removal of substantially all the binder, solvent and dispersant materials. Depending upon the particular flux material used, such heating may also remove substantially all or a portion of the flux materials. In addition, other additional materials could be removed, resulting in a reduced sintering effectiveness and reduced translucency/transparency of the sintered material.

In some embodiments, the suitable temperature for the thermal pre-treatment is higher than the decomposition temperature of the binder resin and/or the organic matter, but is lower than the temperature at which the pores on the surface of the precursor compact are closed off. In some embodiments, the suitable temperature is about 500° C. to about 1000° C. In some embodiments, the thermal pre-treatment time is from 10 minutes to 100 hours, depending on the decomposition speed of the binder resin and the size of the precursor compact or molding.

The precursor compact is then sintered under a non-oxidative or reducing atmosphere to a temperature of at least about 1700° C., 1750° C., 1775° C., 1780° C., 1785° C., 1790° C., 1795° C., and/or 1800° C. but lower than the melting point of the material to thereby form a translucent ceramics. In some embodiment, the precursor compact is heated for a time period of from about 0.5 hours to about 100 hours. In some embodiments, the precursor compact is heated for a time of from about 2 hours to about 24 hours. In some embodiments, the precursor compact is heated for a time of from about 3 hours to about 20 hours. In some embodiments, the precursor compact is heated for a time of from about 4 hours to about 15 hours. In an embodiment, the precursor compact is heated for at least 4.5 hours at a temperature of at least 1775° C. or about 1775° C. In an exemplary embodiment, the precursor compact can be heated to about 1800° C. for about 10 hours. In some embodiments, the precursor compact is sintered under a non-oxidizing or a reducing atmosphere at a temperature of from about 1700° C. to about 1800° C. In some embodiments, the precursor compact is sintered under a non-oxidizing or a reducing atmosphere at a temperature of from about 1700° C. to about 1800° C.

While not intending to be limiting, some embodiments are useful in counteracting or reducing some of the deficiencies of other related methods of preparing ceramic phosphors. For example, sintering under vacuum may be useful to produce void-free phosphor translucent ceramics, but it may not be able to achieve a high luminance efficiency. On the other hand, sintering a precursor compact only under a non-oxidizing or a reducing atmosphere may increase the luminance efficiency of a YAG phosphor, but may result in a slightly reduced sintering property as compared to as performed under a vacuum. However, the so-sintered element provides an improvement over separate sintering and annealing steps, by reducing the need for a subsequent annealing step and the corresponding energy consumption during such second step.

In some embodiments, phosphor translucent ceramics formed by the sintering described above may be subject to further heating under a non-oxidizing or a reducing atmosphere to thereby improve the luminance efficiency. The phosphor translucent ceramics is heated under a non-oxidizing or a reducing atmosphere at a temperature of at least about 1700° C., about 1700° C. to about 1800° C., 1750° C. to about 1790° C., or about 1775° C. In some embodiments, the heating of the phosphor translucent ceramics may occur at a lower temperature than the heating or sintering of the precursor compact. In some embodiments, the heating of the phosphor translucent ceramics under non-oxidizing or a reducing atmosphere may increase its luminance efficiency without significant reduction of translucency of the ceramics.

In some embodiments, the heating of the phosphor ceramic under a non-oxidizing or a reducing atmosphere increases the luminescence efficiency of the resultant translucent phosphor ceramic, where the ceramic is prepared under a different atmospheric condition, e.g., under vacuum or air. Current sintering processes may include the application of temperatures in excess of about 1650° C., e.g., about 1700° C. to about 1750° C., to achieve a desired level of luminescence efficiency. In some embodiments, the application of the sintering step under non-oxidizing or a reducing atmospheric conditions provides an increase in luminescence efficiency despite an initial sintering of the precursor compact at less than such conventional sintering temperatures. Furthermore, the application of the present sintering step under a non-oxidizing or a reducing atmosphere increases the luminescent efficiency of ceramics initially sintered at temperatures in excess of such sintering temperatures, e.g., about 1700° C. Thus irrespective of how the translucent phosphor ceramic is made, the application of a non-oxidizing or a reducing atmosphere at less than the previously disclosed sintering temperatures, e.g., about 1800° C., increases the luminescence efficiency of the resulting translucent phosphor ceramic.

The amount of time for which the material is heated under a non-oxidizing or a reducing atmosphere may vary. In some embodiments, the heating under a non-oxidizing or a reducing atmosphere may occur for about 0.5 hours to about 20 hours, about 5 hours to about 10 hours, about 3 hours to about 7 hours, about 5 hours, or about 10 hours.

A non-oxidizing atmosphere includes an atmosphere that has less of a tendency to oxidize a composition than air, and may include inert atmospheres such as nitrogen, helium, argon, etc., as well as reducing atmospheres. In some embodiments, the non-oxidizing atmosphere may consist essentially of inert gases such as nitrogen, helium, argon, or a combination thereof. Mixtures of inert gases and reducing gases, as well as substantially pure reducing gases, can be reducing atmospheres. The term “reducing atmosphere” includes an atmosphere that has a greater tendency to reduce a composition than air. Examples of reducing atmospheres include atmospheres comprising reducing and/or inert gases such as nitrogen, argon, hydrogen gas, ammonia, hydrazine, carbon monoxide, etc. Any reducing gas may also be diluted with nitrogen gas or an inert gas to provide a reducing atmosphere. For example, a reducing atmosphere may comprise a mixture of from about 1% (v/v) to about 10% (v/v) hydrogen gas (H₂) and about 90% (v/v) to about 99% (v/v) nitrogen gas (N₂), or from about 1% (v/v) to about 5% (v/v) H₂ and about 95% (v/v) to about 99% (v/v) N₂, or about 3%(v/v) H₂ and about 97% (v/v) N₂.

Sintering may occur at any suitable pressure, such as around atmospheric pressure, including about 5 psig to about 30 psig, about 10 psig to about 20 psig, or about 15 psig to about 20 psig.

“Increasing the luminescence efficiency” refers to increasing the fraction of photons that are emitted for each excited electron present in a given translucent phosphor ceramic. The increase is compared to the translucent phosphor ceramic or a similar ceramic, which has not been heated under a reducing atmosphere. In some embodiments, the increased luminescence efficiency is characterized by increased emission from the translucent phosphor ceramic when the ceramic is exposed to radiation within the peak absorption wavelength profile but outside of the peak emissive wavelength profile, which is dependent upon the specific phosphor material. For example, for YAG:Ce3+, monochromatic light at a wavelength of between about 420 nm to about 460 nm is useful. Inventors recognize that inspection of the absorptive and emissive peak profiles can result in other useful radiation wavelengths, e.g., ultraviolet radiation. Although any increase in emission is significant, in some embodiments the increase in emission may be at least about 3%, or at least about 5%, or at least about 8%, or at least about 10%, or at least about 30% as compared to the translucent phosphor ceramic before it is heated under a reducing atmosphere.

In some embodiments, a precursor compact is heated under both vacuum and a reducing atmosphere. This may involve two separate heating steps. For example, the precursor compact could be subjected to a first heating step, allowed to cool to room temperature, and the atmosphere changed, then subjected to a second heating step. In other embodiments, this may also involve a single heating step with a change from a vacuum to a reducing atmosphere or visa versa. In some embodiments, the heating temperature may also be changed when the atmosphere is changed.

In some embodiments, the two heating phases may also be a single step in the sense that the precursor composition remains at an elevated temperature, or is not allowed to completely cool to room temperature, during or between the application of the two distinct atmospheres. For example, it may involve a heating process under different temperatures and the two distinct atmospheres, but which may all occur at elevated temperatures. For example, the vacuum heating may occur at a higher temperature than the heating under the reducing atmosphere, and the temperature may be constant or change during the heating under either or both of the distinct atmospheres.

While not intending to be limiting, in one exemplary process, any binder, solvent, dispersant, and flux material to be used in the process are added to the plurality of phosphor particles or the ceramic raw materials. This composition is mixed and then molded into a precursor compact. The precursor compact is then heated under vacuum to yield a phosphor translucent ceramic. Further heating under a reducing atmosphere then occurs. This heating step improves the luminance efficiency of the phosphor translucent ceramic. Optionally, the precursor compact may be heated in an atmosphere comprising oxygen prior to heating under vacuum to facilitate removal of substantially all of the binder, solvent and dispersant materials. Depending upon the particular flux materials used, such heating may also remove all or a portion of the flux materials.

Another embodiment provides a light emitting device comprising a phosphor translucent ceramic. The light emitting device may be any device which emits light. In one embodiment, the light emitting device is a light emitting diode (LED), an organic light emitting diode (OLED), or an inorganic electroluminescent device (IEL). Since the phosphor translucent ceramics disclosed herein may have high transparency and luminance efficiency, they may be useful when utilized as wavelength down converters for light emitting devices. A large variety of devices may be made which allow the light from the blue-LED to pass through the translucent phosphor ceramics, thus making the light appear more white.

In some embodiments, the phosphor translucent ceramics may be mounted into a blue-LED to yield a device that emits light that appears more white. FIG. 1 shows one of the examples of such a device's structure. In this device, the blue-LED 5 is fixed to a substrate 1, and the phosphor translucent ceramic 10 is positioned so that the blue-LED 5 is between the ceramic 10 and the substrate 1. The blue-LED 5 and ceramic 10 are encapsulated by a resin 15, which is attached to the substrate 1.

In some embodiments, multiple LEDs may be incorporated in to a light emitting device. For example, one embodiment, illustrated in FIG. 2, has several blue-LEDs 5 which are fixed to the substrate 1. The phosphor translucent ceramic 10 in this embodiment is configured so that all of the blue-LEDs 5 are positioned between the substrate 1 and the ceramic 10.

In other embodiments, multiple emitting units comprising a blue-LED 5 and a phosphor translucent ceramic 10 are mounted on the substrate 1. For example, another embodiment illustrated in FIG. 3 has several blue-LEDs 5 fixed to the substrate 1. A multiplicity of the phosphor translucent ceramics 10 are each positioned such that one blue-LED 5 is positioned between the substrate 1 and one of the ceramics 10.

In some embodiments, array type emitting units may also be assembled to form a light emitting device. As depicted in FIG. 4, an array of blue-LEDs 5 is mounted on the substrate 1. A corresponding array of phosphor translucent ceramics plates 10 is formed by embedding the phosphor translucent ceramics plates in the encapsulant resin 15. The matching arrays of phosphor translucent ceramics plates and blue-LEDs are then combined to form a light emitting device that emits whiter light.

Although the depicted phosphor translucent ceramics are flat plates, any shape and thickness of the ceramic may be utilized according to the design requirements.

### Example 1

### Preparation and Evaluation of Emissive Ceramic Sample 1

133.12 g Y₂O₃ particles, 23.81 g Gd₂O₃ particles, 111.63 g Al₂O₃ particles with a BET surface area of 5.6 m²/g, 565 mg CeO₂ particles with a BET surface area of 5.4 m²/g, 45.00 g aqueous acrylic polymer solution as a main component of polymeric binder for final green sheet, 487 mg 2,4,7,9-tetramethyl-5-decyne-4,7-diol ethoxylate as a defoamer for aqueous slurry, 4.87 g 2-amino-2-methyl-1 propanol as a plasticizer, and 125.00 g [Reverse osmosis (RO) water [milli-Q water] were added to a 1.01 high density polyethylene (HDPE) thick wall jar, whose inner diameter is 124 mm (BHB-1100, Kinki Youki, Japan), for aqueous slurry preparation. The Y₂O₃ particles were calcinated at 1400° C. in air to have the desired particle size before this slurry preparation. After the calcinations, the BET surface area of the Y₂O₃ particles was measured to be approximately 2.8 m²/g. Obtained Dₐᵥₑ of the calcinated Y₂O₃ particles was 428 nm based on 5.01 g/cc of the Y₂O₃ density. The Gd₂O₃ particles were also calcinated at 1200° C. in air to have the desired particle size before this slurry preparation. After the calcinations, the BET surface area of the Gd₂O₃ particles was measured to be approximately 1.4 m²/g. Obtained Dₐᵥₑ of the calcinated Gd₂O₃ particles was 578 nm based on 7.41 g/cc of the Gd2O3 density. 1525 g ZrO₂ milling media of 5˜10 mm diameter were added to the HDPE jar. The contents in the PP jar were then shaken by hand until the mixture appeared liquid-like. The mixture in the HDPE jar was milled at about 70 rpm by 700 series “roller-type” jar mill (US Stoneware, East Palestine, Ohio) for about 16 hrs. After ball-milling for the initial 16 hours, additional 55.55 g of the same aqueous acrylic polymer solution was added to the milled solution of ceramic particles in the HDPE jar to finally contain 60 vol % ceramic particles in the final slurry. 4.47 g of polymethylmethacrylate beads (SekiSui Plastics Co., SSX108) were also added to the milled solution in the HDPE jar. Then this mixture was further milled by the roller-type jar mill for about an additional 4 hrs. When the entire ball milling process was completed, the resultant slurry was filtered through a syringe-aided metal screen filter with a pore size of 0.05 mm, in order to remove aggregated ceramic particles. The slurry was then cast on 75 μm thick silicone-coated polyethylene terephthalate Mylar substrate film (Hansung Systems Inc. South Korea) using an automated Model STC-28 tape caster (Hansung Systems, Inc., Pusan, South Korea) at a cast rate of 200 mm/min. The blade gap of the film applicator was adjusted depending on the desired green sheet thickness. The cast tape was dried at about 55˜80° C. at five different heat zones whose length is 0.5 m each to finally obtain either 45 μm thick ceramic green sheet.

The dried green sheet was cut to be about 135 mm×135 mm using a razor blade. Four layers of the 45 μm thick green sheets having the same composition were assembled on an anodized aluminum plate, and this assembly was vacuum-bagged before pressing. This assembly was laminated using a cold isostatic press (CIP) at 40 MPa at 80° C. for 10 min using ILS-66 isostatic lamination press (Keko Equipment, Slovenia). As a result, an approximately 135 mm×135 mm×0.17 mm laminated green laminate was obtained. The green laminate was then laser-cut to the size of 18.5 mm×18.5 mm cubic shape using VLS 2.30 laser engraving and cutting system (Universal Laser Systems) with 25 W CO₂ laser for the following Bisk firing and sintering processes.

As the next step, the polymeric binder was removed from the green laminates. The laminated compacts were sandwiched between Al₂O₃ porous cover plates with 40% nominal porosity (ESL ElectroScience, King of Prussia, Pa.), in order to avoid the warping, cambering and bending of the laminated compacts during debinding process. A plurality of green sheets was stacked between porous Al₂O₃ cover plates alternatively. The laminated compacts were heated to about 1200° C. for about 2 hours in air using a ST-1700C-445 box furnace (SentroTech Corporation, Brea Ohio). The heating and cooling rates were <0.7° C./min and <4.0° C./min, respectively. The debinded compacts were fully sintered at 1775° C. for about 5 hours under N2 containing 3% H2 using a high temperature furnace whose heating elements and heat shields were made of tungsten and molybdenum. The heating rate of this sintering process was about 16.7° C./min (˜400° C.), 8.0° C./min (400˜1000° C.), 2.5° C. (1000˜1400° C.), 1.7° C./min (1400˜1500° C.), and 0.75° C./min (1500˜1800° C.), whereas the cooling rate was 8.0° C./min in order to minimize cracking during sintering. In addition, a second heating or annealing was performed upon the green sheets. 0.25 at % Ce-doped and 10.0 at % Gd-doped YAG ceramics was obtained after the end of sintering. When further re-oxidation process is conducted after the end of sintering, the re-oxidation condition was at about 1400° C. for about 2 hours under low vacuum pressure (˜20 Torr) at a heating and cooling rate of <4.0° C./min using GSL-1700X-80 bench-top single zone tube furnace (MTI Corporation, Richmond, Calif.).

### Examples 2-12, Comparative Examples 1-6

Examples 2-12 and Comparative Examples 1-6 where made in a similar manner to that described in Example 1, except that: (a) in some cases no polymeric beads or different polymeric beads (Nippon Shokubai, M1006) were inserted instead of SekiSui SSX108; (b) in some cases, the green sheet was densified or sintered under different atmospheric conditions instead of 3% H₂-97% N₂; and/or (c) the green sheet was densified or sintered under different temperatures and/or lengths of time instead of 1775° C. and/or about 5 hours, as described in

Table 1 below:

TABLE 1

| | | Sintering | Sintering | Sintering |
|---|---|---|---|---|
| Example | beads | atmosphere | temperature | time |
| 2 | SSX108 | vacuum | 1775° C. | about 5 hrs |
| 3 | SSX108 | 100% ultra high | 1775° C. | About 5 hrs |
| | | purityN₂ | | |
| 4 | SSX108 | (liquid) Bulk N2 | 1775° C. | About 5 hrs |
| 5 | SSX108 | (Liquid bulk | 1775° C. | About 5 hrs |
| | | argon) | | |
| 6 | SSX108 | N2—O2 mixture | 1775° C. | About 5 hrs |
| 3-A | SSX108 | (liquid) Bulk N2 | 1800° C. | About 10 hrs |
| 7 | MA1006 | 3%H2—97%N2 | 1775° C. | About 5 hrs |
| 8 | MA1006 | vacuum | 1775° C. | About 5 hrs |
| 9 | MA1006 | 100% ultra high | 1775° C. | About 5 hrs |
| | | purityN₂ | | |
| 10 | MA1006 | (liquid) Bulk N2 | 1775° C. | About 5 hrs |
| 11 | MA1006 | (Liquid bulk | 1775° C. | About 5 hrs |
| | | argon) | | |
| 12 | MA1006 | N2—O2 mixture | 1775° C. | About 5 hrs |
| 10-A | MA1006 | (liquid) Bulk N2 | 1800° C. | About 10 hours |
| Compar- | none | 3%H2—97%N2 | 1775° C. | About 5 hours |
| ative-1 | | | | |
| Compar- | none | vacuum | 1775° C. | About 5 hours |
| ative-2 | | | | |
| Compar- | none | 100% ultra high | 1775° C. | About 5 hours |
| ative-3 | | purityN₂ | | |
| Compar- | none | (liquid) Bulk N2 | 1775° C. | About 5 hours |
| ative-4 | | | | |
| Compar- | none | (Liquid bulk | 1775° C. | About 5 hours |
| ative-5 | | argon) | | |
| Compar- | none | N2—O2 mixture | 1775° C. | About 5 hours |
| ative-6 | | | | |
| Compar- | none | (liquid) Bulk N2 | 1800° C. | About 10 hours |
| ative 1-A | | | | |

The total transmittance of the obtained YAG ceramics was measured by high sensitivity multi channel photo detector (MCPD 7000, Otsuka Electronics, Inc., Japan). First, continuous spectrum light irradiated from a halogen lamp source at 150 W (MC2563, Otsuka Electronics, Inc., Japan) with no sample in the sample holder to obtain air reference transmission data. Next the ceramic sample was placed in the sample holder irradiated with the same halogen lamp source. The transmitted spectrum was acquired for each sample by the multi channel photo detector. The value of the total transmittance at 800 nm wavelength of light was used as a quantitative value of transparency of each ceramics.

IQE measurements were performed with an Otsuka Electronics MCPD 7000 multi-channel photo detector system (Osaka, JPN) together with required optical components such as integrating spheres, light sources, monochromator, optical fibers, and sample holder as described below.

The YAG:Ce emissive ceramic elements constructed as described above, with a diameter of about 11 mm, were placed on a light emitting diode (LED) with peak wavelength at 455 nm with acrylic lens which had a refractive index of about 1.45. An LED with YAG:Ce was set up inside integration sphere. The YAG:Ce ceramics elements were irradiated by the LED and the optical radiation of blue LED and YAG:Ce ceramics were recorded respectively. Next, the YAG:Ce ceramics plate was removed from LED, and then the radiation of blue LED with the acrylic lens were measured.

IQE was calculated by integration of the radiation difference from the blue only LED and blue LED/Ceramic combination. The results of the Total transmittance and the IQE determinations are as shown in Table 2 (Translucent YAG using SSX-108 beads), Table 3 (Translucent YAG using M1006 beads), and Table 4 (Translucent YAG without beads) below and are graphically depicted in FIGS. 5 and 6. Multiple samples made under similar conditions are indicated by the second label, e.g., Ex-4-1 and Ex-4-2. As shown below, the annealing or second heating increased 40% and 10% of the IQE of the materials sintered in vacuum and N₂′ 3% H₂, respectively. On the other hand, the annealing only improved 1-3% of the IQE of the materials sintered in nitrogen. Under the same sintering temperature and time, the nitrogen sintered material has slightly lower IQE, and the IQE can be raised to the same level with increases in sintering temperature and time.

TABLE 2

| | | Sintering | | | | | |
|---|---|---|---|---|---|---|---|
| | Sintering | Environ- | Thickness | Sintered | Annealed | Sintered | Annealed |
| Ex # | Condition | ment | μm | IQE % | IQE % | T % | T % |
| 2-1 | 1775° C. | Vacuum | 140 ± 6 | 57.8 ± 2.9 | 94.9 ± 0.8 | 60.0 ± 0.9 | 62.7 ± 0.7 |
| 2-2 | 5 Hrs | | 140 ± 3 | 61.3 ± 7.0 | 93.8 ± 1.4 | 62.4 ± 1.1 | 64.5 ± 0.9 |
| 1-1 | | N₂—3% H₂ | 147 ± 3 | 85.2 ± 0.8 | 96.3 ± 0.4 | 62.7 ± 0.5 | 63.4 ± 0.5 |
| 1-2 | | | 143 ± 2 | 83.7 ± 0.5 | 96.4 ± 0.1 | 63.1 ± 1.7 | 63.9 ± 0.4 |
| 3-1 | | UHP N₂ | 142 ± 4 | 92.9 ± 0.9 | 93.2 ± 1.5 | 61.3 ± 1.0 | 61.5 ± 0.9 |
| 3-2 | | | 140 ± 4 | 95.8 ± 0.3 | 95.0 ± 1.1 | 63.5 ± 1.3 | 63.4 ± 1.1 |
| 4-1 | | Bulk N₂ | 141 ± 3 | 93.7 ± 0.6 | 94.7 ± 0.8 | 61.9 ± 0.6 | 62.7 ± 0.8 |
| 4-2 | | | 144 ± 2 | 82.7 ± 0.9 | 88.5 ± 0.7 | 61.9 ± 0.6 | 62.5 ± 0.9 |
| 4-3 | | | 144 ± 3 | 87.2 ± 0.6 | 92.1 ± 1.5 | 63.1 ± 1.8 | 62.4 ± 1.4 |
| 4-4 | | | 140 ± 3 | 92.1 ± 0.2 | 90.2 ± 0.2 | 62.1 ± 1.5 | 63.4 ± 1.7 |
| 5 | | Bulk Ar | 140 ± 3 | 90.1 ± 0.6 | 91.1 ± 0.4 | 58.6 ± 0.7 | 58.5 ± 1.0 |
| | | N₂—0.05% | 139 ± 3 | 89.8 ± 0.2 | 93.0 ± 0.8 | 80.8 ± 5.5 | 81.7 ± 5.4 |
| | | O₂ | | | | | |
| 4-A | 1800° C. | Bulk N₂ | 142 ± 2 | 96.3 ± 0.3 | 97.0 ± 0.6 | 74.6 ± 2.1 | 76.0 ± 3.2 |
| | 10 Hrs | | | | | | |

TABLE 3

| | | | Thick- | | | | |
|---|---|---|---|---|---|---|---|
| | Sintering | Sintering | ness | Sintered | Annealed | Sintered | Annealed |
| Ex # | Conditions | Environment | μm | IQE % | IQE % | T % | T % |
| Ex-8 | | Vacuum | 130 ± 2 | 77.6 ± 3.2 | 98.3 ± 0.9 | 59.7 ± 0.9 | 62.9 ± 0.7 |
| Ex-7 | | N₂—3% H₂ | 134 ± 3 | 80.0 ± 2.7 | 95.5 ± 0.3 | 60.6 ± 1.8 | 64.0 ± 0.6 |
| Ex-9 | 1775° C. | UHP N₂ | 132 ± 3 | 94.9 ± 0.3 | 94.3 ± 0.3 | 63.2 ± 1.1 | 63.1 ± 0.8 |
| | 5 Hrs | | | | | | |
| Ex- | | Bulk N₂ | 135 ± 4 | 94.6 ± 0.8 | 94.1 ± 0.2 | 61.3 ± 0.6 | 60.6 ± 1.1 |
| 10 | | | | | | | |
| Ex- | | Bulk Ar | 132 ± 3 | 94.2 ± 0.2 | 94.0 ± 0.6 | 59.0 ± 0.8 | 58.9 ± 0.7 |
| 11 | | | | | | | |
| Ex- | 1800° C, | Bulk N₂ | 132 ± 3 | 96.4 ± 1.1 | 96.2 ± 0.4 | 70.5 ± 1.4 | 71.0 ± 1.2 |
| 10-A | 10 Hrs | | | | | | |

TABLE 4
Transparent [YAG: No beads]

| | | Sintering | Thick- | Sintered | | | |
|---|---|---|---|---|---|---|---|
| | Sintering | Environ- | ness | IQE | Annealed | Sintered | Annealed |
| Ex # | Conditions | ment | μm | % | IQE % | T % | T % |
| CE-2 | 1775° C. | Vacuum | 142 ± 2 | 72.9 ± 9.7 | 96.7 ± 0.8 | 79.7 ± 0.7 | 81.8 ± 0.5 |
| CE-1 | 5 Hrs | N₂—3% H₂ | 144 ± 1 | 83.5 ± 2.3 | 98.4 ± 0.1 | 85.9 ± 0.7 | 86.3 ± 0.2 |
| CE-3 | | UHP N₂ | 142 ± 3 | 96.4 ± 0.4 | 96.4 ± 0.2 | 71.9 ± 0.5 | 71.8 ± 0.5 |
| CE-4 | | Bulk N₂ | 144 ± 2 | 94.2 ± 0.2 | 94.1 ± 1.0 | 71.7 ± 0.5 | 71.3 ± 1.0 |
| CE-5 | | Bulk Ar | 143 ± 2 | 93.5 ± 0.3 | 93.3 ± 0.5 | 65.0 ± 0.2 | 65.0 ± 0.4 |
| CE-6 | | N₂—0.05% | 141 ± 4 | 95.1 ± 0.8 | 95.0 ± 1.1 | 80.8 ± 5.5 | 81.7 ± 5.4 |
| | | O₂ | | | | | |
| CE- | 1800° C. | Bulk N₂ | 142 ± 3 | 95.7 ± 0.5 | 96.3 ± 0.1 | 78.0 ± 1.3 | 79.3 ± 1.4 |
| 4A | 10 Hrs | | | | | | |

### Scanning Electron Microscopy (SEM) Analysis

The morphologies of the yttrium aluminum oxide compact prepared as described above were also observed by scanning electron microscopy. FIG. 7 shows SEM micrographs of the yttrium aluminum oxide compacts prepared as described above. The average grain size and light scattering voids appeared similar for the compacts sintered in vacuum and N2-3% H2. The pure nitrogen atmosphere promoted the grain growth. Increases in sintering temperature (1800 C) and time (10 hours) slightly increased the average grain size (from 6.8 to 7.4 micron), and also removed the light scattering voids significantly, leading to a dramatic 13% increase in light transmission.

It will be appreciated by those skilled in the art that various omissions, additions and modifications may be made to the processes described above without departing from the scope of the invention, and all such modifications and changes are intended to fall within the scope of the invention.

What is claimed is:

1. A method of increasing the luminescence efficiency of a translucent phosphor ceramic, comprising:
sintering a ceramic phosphor precursor in a non-oxidizing atmosphere at a temperature of at least about 1700° C. thereby increasing the luminescence efficiency.

2. The method of claim 1, wherein the non-oxidizing atmosphere comprises between 94% to about 100% inert gas and about 0% to about 6% reducing gas.

3. The method of claim 1, wherein the temperature is lower than the melting point of the translucent phosphor ceramic.

4. The method of claim 3, wherein the temperature is from about 1700° C. to about 1850° C.

5. The method of claim 4, wherein the temperature is from about 176000° C. to about 1850° C.

6. The method of claim 4, wherein the heating is at a temperature of from about 1700° C. to about 1850° C. for a period of from about 3 to about 15 hours.

7. The method of claim 1, wherein non-oxidizing atmosphere comprises hydrogen gas.

8. The method of claim 7, wherein the non-oxidizing atmosphere comprises a mixture of from about 0% (v/v) to about 6% (v/v) hydrogen gas and about 100% (v/v) to about 94% (v/v) nitrogen gas.

9. The method of claim 1, wherein the non-oxidizing atmosphere consists essentially of nitrogen gas.

10. The method of claim 1, wherein the non-oxidizing atmosphere consists essentially of argon gas.

11. The method of claim 1, wherein the translucent phosphor ceramic is prepared by a process comprising heating the ceramic phosphor precursor at a temperature of from about 1700° C. to about 2000° C. under the non-oxidizing atmosphere, wherein the non-oxidizing atmosphere is a reducing atmosphere.

12. The method of claim 9, wherein the ceramic phosphor precursor is heated at a temperature of from about 1700° C. to about 2000° C. under a reducing atmosphere for about 3 to about 8 hours.

13. The method of claim 9, wherein the ceramic phosphor precursor comprises a rare earth garnet powder.

14. The method of claim 1, wherein said translucent phosphor ceramic comprises a rare earth doped phosphor material having garnet structure.

15. The method of claim 1, wherein said translucent phosphor ceramic comprises a composition of (A₁₋ₓEₓ)₃B₅O₁₂, wherein
A is Y, Gd, La, Lu, Tb, or a combination thereof;
x is from about 0.00005 to about 0.1;
B is Al, Ga, In, or a combination thereof; and
E is Ce, Eu, Tb, Nd, or a combination thereof.

16. The method of claim 15, wherein x is from about 0.0001 to about 0.01

17. The method of claim 15, wherein x is from about 0.001 to about 0.005.

18. The method of claim 15, wherein A is Y.

19. The method of claim 15, wherein E is Ce.

20. The method of claim 15, wherein B is Al.

21. The method of claim 15, wherein said translucent phosphor ceramic comprises (YaGd_{b}Ce_{c})₃B₅O₁₂, wherein a+b+c is about 1.

22. The method of claim 21, wherein a is about 0.9.

23. The method of claim 21, wherein b is about 0.1.

24. The method of claim 21, wherein c is about 0.0005

25. A method of manufacturing a phosphor translucent ceramic having increased luminescence comprising:
sintering a ceramic phosphor precursor.

26. The method of claim 25 wherein the ceramic phosphor precursor comprises a rare earth doped phosphor material having garnet structure.

27. The method of claim 225 wherein ceramic phosphor precursor comprises YAG:Ce powder.

28. A method of manufacturing a phosphor translucent ceramic having increased luminescence comprising:
heating a ceramic phosphor precursor at a temperature of at least about 1200° C. under a reducing atmosphere.
